(19) United States
(12) Patent Application Publication
(10) Pub. No.: US 2018/0003250 A1
(43) Pub. Date: Jan. 4, 2018

(54) Protective Cover for Temporary Protective Shielding of Brake

(71) Applicant: KUNSHAN MMK AUTOMOTIVE CO., LTD, Jiangsu (CN)

(72) Inventor: Gaihe Liu, Jiangsu (CN)

(73) Assignee: KUNSHAN MMK AUTOMOTIVE CO., LTD, Jiangsu (CN)

(21) Appl. No.: 15/547,453

(22) PCT Filed: Jan. 29, 2016
(86) PCT No.: PCT/CN2016/072683

§ 371 Date: Jul. 28, 2017

(30) Foreign Application Priority Data
Jan. 30, 2015 (CN) 201520070122.8

(51) Int. Cl. F16D 65/00; F16D 55/00

(52) U.S. Cl. CPC F16D 65/0025; F16D 65/0081; F16D 2055/0037

(57) ABSTRACT

A cover for temporary protective shielding of a brake includes a body. The body has a cylindrical structure with one open end; a central position of an upper bottom surface of the cover body includes a central hole; a front-end position of the upper bottom surface includes a downwardly recessed mounting groove for mounting a brake caliper; a limiting step for position limiting is provided at a connection and transition position between a front-end inner circumferential wall and an inner circumferential wall of the body; the inner circumferential wall includes snap joints and heat radiating grooves; the inner circumferential wall of the protective cover body includes compensation columns that protrude outwards from the inner circumferential wall. The cover is mounted on a peripheral edge of the brake protective plate. By using compensation columns with a hollow semi-cylindrical structure, the cover can be universally mounted at peripheral edges of protective plates having various shapes.

### TECHNICAL FIELD

The present application relates to the field of brake protective covers, and in particular, to a protective cover for temporary protective shielding of a brake.

### BACKGROUND ART

Brakes of vehicles, such as brake discs and brake drums, are prone to corrosions because these components cannot be coated with any surface coating. When a vehicle is used, the brake is frequently used, and parts that are prone to corrosion would be abraded quickly. Before the vehicle is shipped and put into use, if no specific anticorrosion measure is taken, a braking surface will be corroded easily.

A currently universal anticorrosion measure is that: before a vehicle is shipped and put into use, a protective cover is added to the wheel, to temporarily shield a brake disc and a brake caliper. For example, WO2008/004977A1 discloses a protective cover for temporary protective shielding of a braking system on vehicle wheels; the protective cover is firmly fastened on the peripheral edge of the protective plate through a snap element, to shield and substantially close off the corrosion-prone parts of the brake on the wheel. The defect of the structure thereof lies in that: peripheral edges of brake protective plates of various vehicle models have different shapes and structures: some peripheral edges have a larger diameter on the left and a smaller diameter on the right, peripheral edges of some protective plates are complete on the left and have a piece missing on the right, and some brake discs have smaller diameters; currently, there is no protective cover adaptable to multiple types of protective plates, and this is the problem to be solved by the present application.

### SUMMARY

An objective of the present application is to provide a protective cover for temporary protective shielding of a brake, to overcome the defect of the prior art.

The objective of the present application is accomplished by using the following technical solution. The protective cover for temporary protective shielding of a brake mainly includes a protective cover body, wherein the protective cover body has a cylindrical structure with one open end; a central position of an upper bottom surface of the protective cover body is provided with a central hole; a front-end position of the upper bottom surface of the protective cover body is provided with a downwardly recessed mounting groove for mounting a brake caliper; a limiting step for position limiting is provided at a connection and transition position between a front-end inner circumferential wall and an inner circumferential wall of the protective cover body; the inner circumferential wall is provided with several snap joints and heat radiating grooves; the inner circumferential wall of the protective cover body is provided with several compensation columns, and the compensation columns protrude outwards from the inner circumferential wall; an inwardly recessed hollow semi-cylindrical structure is formed on a corresponding outer circumferential wall, and shape compensation is implemented by pressing the compensations columns.

The front-end inner circumferential wall of the protective cover body is provided with a snap joint A, and the snap joint A is located at a position facing the center of the mounting groove; snap joints B are symmetrically disposed on left and right sides of the inner circumferential wall close to the limiting step, and a rear-end inner circumferential wall is provided with a snap joint C.

The bottom surface of the protective cover body on the periphery of the central hole is provided with a group of rip wires.

The rip wires are semi-arc-shaped, and are symmetrically distributed according to the central hole.

The compensation columns are symmetrically disposed on the left and right sides of the inner circumferential wall close to the limiting step.

The compensation columns are provided with a guiding slope for easy insertion and positioning.

The outer circumferential wall of the protective cover body is provided with a stacking slope for easy insertion.

The present application has the following beneficial effects: compensation columns with a hollow semi-cylindrical structure are used, and the protective cover is mounted on a peripheral edge of a brake protective plate; by means of the compensation columns, the cover of the present application can be universally mounted at peripheral edges of protective plates having various shapes, thereby addressing the problem of how to enable a protective cover to be adaptable to various types of protective plates.

### BRIEF DESCRIPTION OF THE DRAWINGS

FIG. 1 is a front schematic structural view of a brake cover constructed in accordance with the teachings of the present application;

FIG. 2 is a left schematic structural view of the brake cover;

FIG. 3 is a stereo schematic structural view of a longitudinal section of the brake cover;

FIG. 4 is a top stereo schematic structural view of a traverse section of the brake cover; and

FIG. 5 is a bottom stereo schematic structural view of a traverse section of the brake cover.

Reference signs in the drawings: protective cover body 1, snap joint A2, mounting groove 3, limiting step 4, central hole 5, rip wire 6, snap joint B-7, compensation column 8, heat radiating groove 9, snap joint C-10, stacking slope 11, guiding slope 12, front-end inner circumferential wall 13, bottom surface 14, inner circumferential wall 15.

### DETAILED DESCRIPTION OF THE PREFERRED EMBODIMENTS

The present invention is described below in detail with reference to the accompanying drawings.

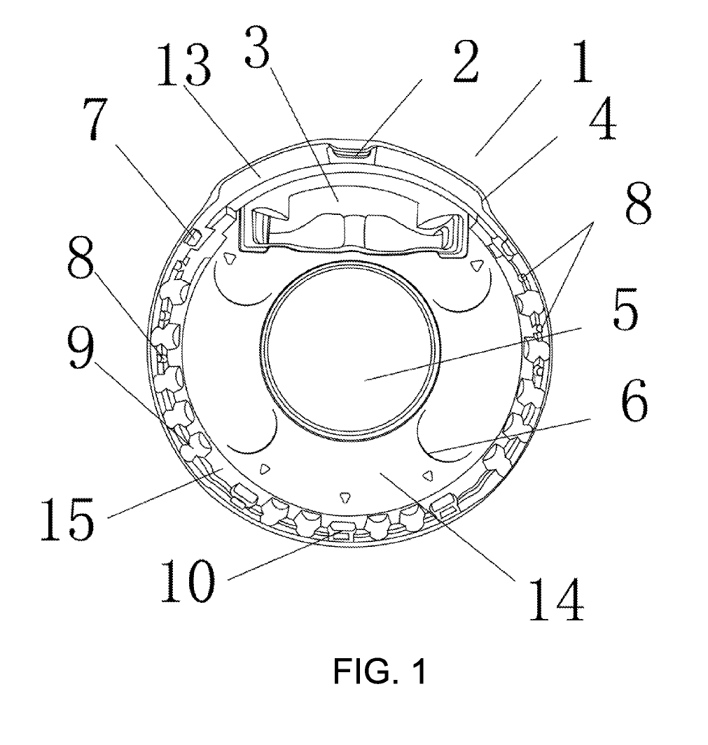

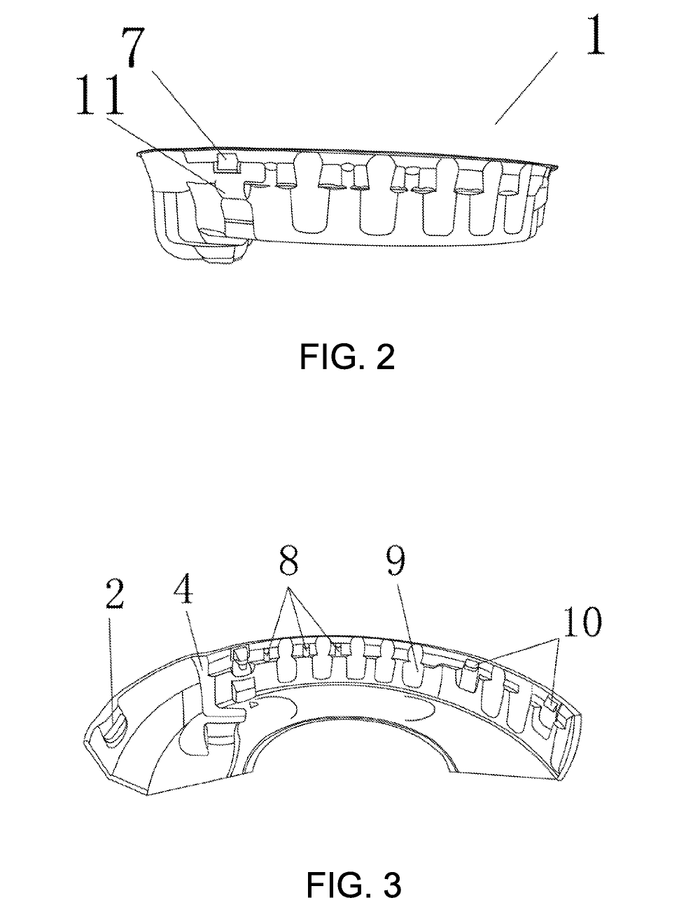

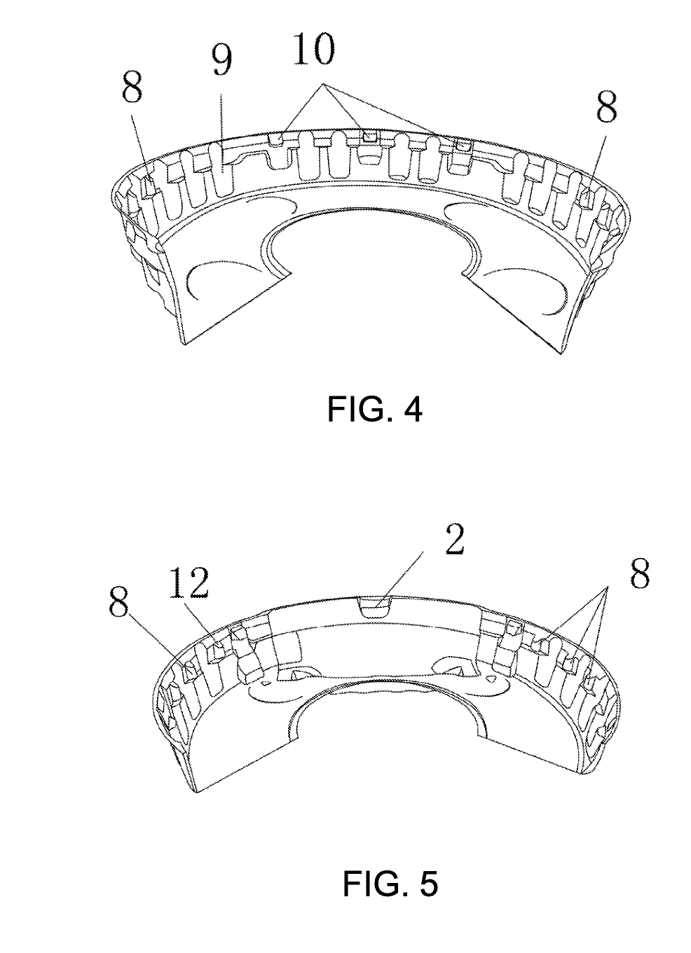

As shown in FIG. 1 to FIG. 5, the protective cover for temporary protective shielding of a brake mainly includes a protective cover body 1, wherein the protective cover body 1 has a cylindrical structure with one open end. A central position of an upper bottom surface 14 of the protective cover body 1 is provided with a central hole 5. A front-end position of the upper bottom surface 14 of the protective cover body 1 is provided with a downwardly recessed mounting groove 3 for mounting a brake caliper. A limiting step 4 for position limiting is provided at a connection and transition position between a front-end inner circumferential wall 13 and an inner circumferential wall 15 of the protective cover body 1. The inner circumferential wall 15 of the protective cover body 1 is provided with several compensation columns 8 and heat radiating grooves 9. The compensation columns 8 are symmetrically disposed on left and right sides of the inner circumferential wall 15 close to the limiting step 4 (in this embodiment, the left and right sides are each provided with three compensation columns 8). The compensation columns 8 protrude outwards from the inner circumferential wall 15. An inwardly recessed hollow semi-cylindrical structure is formed on a corresponding outer circumferential wall, and shape compensation is implemented by pressing the compensations columns 8. The compensation columns 8 are provided with a guiding slope 12 for easy insertion and positioning.

A working principle is described as follows: peripheral edges of brake protective plates of various vehicle models have different shapes and structures, and when a peripheral edge has a larger diameter on the left and a smaller diameter on the right, or a peripheral edge has a smaller diameter on the left and a larger diameter on the right, because the compensation column uses a hollow semi-cylindrical structure, the compensation column can be pressed by means of the peripheral edge and thus be deformed, thereby achieving the adjustment and compensation purpose. For some protective plates whose peripheral edges are complete on the left and have a piece missing on the right (or the other way round), if a common protective cover is used, a gap may occur between the snap joint of the protective cover and a position where a piece of the peripheral edge is missing, and therefore, the vehicle may generate screeching during driving. However, a protruding part of the compensation column used in the present application faces the position where a piece is missing; in this case, a compensation column engaged with the left side of the peripheral edge is deformed, and a compensation column engaged with the position where a piece is missing on the right side of the peripheral edge is not deformed, so that the gap can be effectively filled, and no screeching is generated any more.

Two snap joints B7 are symmetrically disposed on the left and right sides of the inner circumferential wall 15 close to the limiting step 4, and a rear-end inner circumferential wall is provided with three snap joints C10. Through the limiting step 4, the snap joints B7, and the snap joints C10, multi-point positioning clamping is formed. The front-end inner circumferential wall 13 of the protective cover body 1 is provided with a snap joint A2, and the snap joint A2 is located at a position facing the center of the mounting groove 3. For some smaller brake calipers, the mounting groove 3 cannot be closely fit with the brake caliper, and the limiting step 4 plays a less important role, and the reliability of positioning needs to be ensured by using the snap joint A2.

The bottom surface of the protective cover body 1 on the periphery of the central hole 5 is provided with 4 rip wires 6, and the rip wires 6 are semi-arc-shaped, and are symmetrically distributed according to the central hole 5. With such a structure design, after the vehicle is put into use, the protective cover can be conveniently torn off from the brake.

The outer circumferential wall of the protective cover body 1 is provided with a stacking slope 11 for easy insertion, and during vanning, the stacking slope 11 allows multiple protective covers to be stacked conveniently, thus minimizing the volume.

It can be understood that, for a person skilled in the art, any equivalent replacement or change on the technical solution of the present application and the concept of the present application should belong to the protection scope of the appended claims of the present application.

1. A protective cover for temporary protective shielding of a brake, mainly comprising a protective cover body, wherein the protective cover body has a cylindrical structure with one open end; a central position of an upper bottom surface (14) of the protective cover body is provided with a central hole; a front-end position of the upper bottom surface of the protective cover body is provided with a downwardly recessed mounting groove for mounting a brake caliper; a limiting step for position limiting is provided at a connection and transition position between a front-end inner circumferential wall and an inner circumferential wall of the protective cover body; the inner circumferential wall is provided with several snap joints and heat radiating grooves; the inner circumferential wall of the protective cover body is provided with several compensation columns and the compensation columns protrude outwards from the inner circumferential wall; an inwardly recessed hollow semi-cylindrical structure is formed on a corresponding outer circumferential wall, and shape compensation is implemented by pressing the compensations columns.

2. The protective cover for temporary protective shielding of a brake according to claim 1, wherein the front-end inner circumferential wall of the protective cover body is provided with a snap joint A, and the snap joint A is located at a position facing the center of the mounting groove; snap joints B are symmetrically disposed on left and right sides of the inner circumferential wall close to the limiting step, and a rear-end inner circumferential wall is provided with a snap joint C.

3. The protective cover for temporary protective shielding of a brake according to claim 1, wherein the bottom surface of the protective cover body on the periphery of the central hole is provided with a group of rip wires.

4. The protective cover for temporary protective shielding of a brake according to claim 3, wherein the rip wires are semi-arc-shaped, and are symmetrically distributed according to the central hole.

5. The protective cover for temporary protective shielding of a brake according to claim 1, wherein the compensation columns are symmetrically disposed on the left and right sides of the inner circumferential wall close to the limiting step.

6. The protective cover for temporary protective shielding of a brake according to claim 1, wherein the compensation columns are provided with a guiding slope for easy insertion and positioning.

7. The protective cover for temporary protective shielding of a brake according to claim 1, wherein the outer circumferential wall of the protective cover body is provided with a stacking slope for easy insertion.
